(19) United States
(12) Patent Application Publication
(10) Pub. No.: US 2004/0130870 A1
(43) Pub. Date: Jul. 8, 2004

(54) System and method for heat removal from a hand-held portable computer while docked

(75) Inventors: Rod G. Fleck, Bellevue, WA (US); Livius D. Chebeleu, San Jose, CA (US); Oliver R. Roup, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Vulcan Portals Inc., Seattle, WA

(21) Appl. No.: 10/338,802

(22) Filed: Jan. 7, 2003

(51) Int. Cl. G06F 1/16

(52) U.S. Cl. 361/687; 361/703; 361/686

(57) ABSTRACT

Heat is removed from a docked portable computer. Due to the heat removal, the portable computer can operate at full design voltage and frequency while docked, and thereby provide maximum performance, without sacrificing performance in order to generate less heat. A docking station provides a thermal docking connection. The thermal docking connection is implemented using a first set of fins of the portable computer that is mated to a second set of fins in the docking station. The second set of fins in the docking station is then, via use of heat conductive materials, exposed to forced airflow from a fan within the docking station. Other embodiments of heat-removal methods, such as larger surface areas, peltia devices, water cooling, and others, can be used to pull additional heat from the docked portable computer. Thus, the docking station acts as an “air-conditioner” for the portable computer, and allows the portable computer to operate at higher frequencies.

### BACKGROUND OF THE INVENTION

1. Field of the Invention

The present disclosure relates generally to heat transfer and heat dissipation techniques, and in particular but not exclusively, relates to removal of heat generated from a docked hand-held device, such as a portable computer, by transferring and dissipating the heat via a docking station.

2. Description of the Related Art

Many laptops or other hand-held devices create 10-30 watts of power from processors, graphics systems, disk drives, memory systems, display drivers, backlights, and other components. This generated power is in the form of heat that must be moved away from the heat-generating chip(s) to the outside of the device. Failure to properly dissipate the heat can lead to device failure, permanent damage to the device, and potential fire or burn injury to a user.

Modern laptops use heat-pipes, heat sinks, and fan(s) to pull the heat to the outside surface or air. Newer smaller personal computers (PCs), such as sub-notebooks and ultra-portable computers, have three primary issues that influence their design and operation. First, as compared to conventional-sized PCs, it is more difficult to build extremely small devices while still leaving sufficient room for airflow. Second, it is difficult and undesirable to have a fan running in the device, due to size, weight, power, and noise issues. Third, these smaller devices have a significantly smaller surface area (in many cases less than ¼ of the area of a conventional-sized PC) to dissipate heat, which results in far higher temperatures on surfaces, thereby potentially causing burning (of the user's skin, for instance) or external fire.

Many of these newer and smaller devices are taking advantage of newer integrated chip (IC) technology that allows less power dissipation per task. Smaller device geometries on IC require lower voltages that allow lower heat generation. They can also allow higher performance, but a trade-off must be made between using the available additional performance against the heat that would be generated. Therefore, many solutions have opted for lower performance and lower voltage operation to solve these heat dissipation issues. This is unfortunate for users because such devices are losing the opportunity to provide higher performance.

### BRIEF SUMMARY OF THE INVENTION

According to one aspect of the invention, a portable device is provided that generates heat during operation. A docking station has a connection to accommodate the portable device, with the connection being coupleable to the portable device to receive the heat generated by the portable device during operation of the portable device while in the docking station. A heat transport mechanism is included with the docking station to substantially remove the heat received by the connection.

### BRIEF DESCRIPTION OF THE SEVERAL VIEWS OF THE DRAWINGS

Non-limiting and non-exhaustive embodiments of the present invention are described with reference to the following figures, wherein like reference numerals refer to like parts throughout the various views unless otherwise specified.

FIG. 1 shows a portable hand-held computer in accordance with an embodiment of the invention.

FIG. 2 shows fins located at an underside surface of the portable computer of FIG. 1 in accordance with an embodiment of the invention.

FIG. 3 depicts heat removal from a docked portable computer in accordance with a first embodiment of the invention.

FIGS. 4-5 illustrate example fin-mating implementations that are usable for the embodiment of FIG. 3.

FIG. 6 symbolically illustrates a peltia device.

FIG. 7 depicts heat removal from a docked portable computer, using the peltia device of FIG. 6, in accordance with a second embodiment of the invention.

FIG. 8 depicts heat removal from a docked portable computer in accordance with a third embodiment of the invention.

FIG. 9 illustrates heat removal from the underside surface of a docked portable computer in accordance with a fourth embodiment of the invention.

### DETAILED DESCRIPTION

Embodiments of techniques to remove or reduce heat from a docked hand-held device, such as a portable computer, via a docking station are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, an embodiment of the invention is directed towards heat removal from a hand-held device, such as a portable computer. The portable computer of an embodiment of the invention comprises a miniature hand-held computer that is substantially smaller in size than a conventional laptop. As a result of the heat removal techniques provided by embodiments of the invention, the portable computer can operate at full design voltage and frequency while docked, and thereby provide maximum performance, without the necessity of having to sacrifice performance in order to generate less heat.

According to an embodiment of the invention, heat may be removed from the portable computer while it is docked in a docking station. A docking station may provide users with additional interfaces (such as serials ports, monitor ports, Universal Serial Bus and IEEE 1394 ports, and other interfaces) and additional media devices (CD, DVD, additional disk, and etc.) to complete a substantially full laptop/desktop experience. An embodiment allows full voltage and/or frequency operation while the portable computer is docked, by not only creating an electrical docking connection but also a thermal docking connection. The thermal docking connection allows far more heat to be drawn from the portable computer than is possible with normal air or hand-held implementations.

In accordance with an embodiment of the invention, the thermal docking connection is implemented using a first set of fins of the portable computer that is substantially mated to a second set of fins in the docking station. The second set of fins in the docking station is then, via use of heat conductive materials, exposed to forced airflow from a fan within the docking station. Other embodiments of heat-removal methods, such as larger surface areas, peltia devices, water cooling, and others, can be used to pull additional heat from the docked portable computer.

Materials at the bottom of the portable computer (or other surfaces that thermally mate with the docking station) and corresponding surfaces on the docking station are heat conductive. A magnesium alloy may be used, but other materials are possible. In short, the docking station acts as an “air-conditioner” for the portable computer.

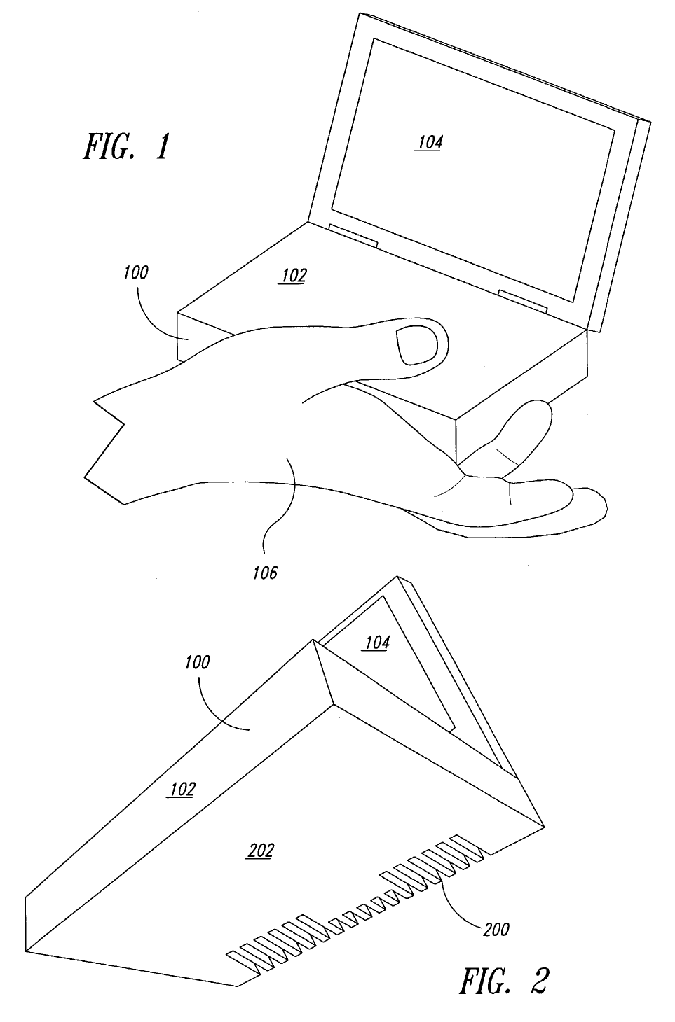

FIG. 1 shows a portable hand-held computer 100 in accordance with an embodiment of the invention. While the portable computer 100 is used as the illustrative example throughout this application, it is appreciated that other embodiments of the invention may be implemented with devices that may not necessarily be thought of as a “computer” by the average individual. Examples include wireless communication devices, display devices, monitors, audiovideo equipment, consumer electronic devices, or other electronic device that can have a reduced form factor and which can potentially have heat dissipation problems that are addressable by the heat removal techniques described herein.

As shown, the portable computer 100 is similar in appearance to a laptop, in that it comprises first and second portions 102 and 104, respectively. The first portion 102 can include a keyboard and housing for the internal electronic components (such as a processor, disk drives, graphics drivers, and so forth). The second portion 104 folds over the first portion 102 (when in a closed position), and includes a display screen for displaying information while the second portion 104 is unfolded to an upright position (as shown in FIG. 1).

Unlike a conventional laptop, however, the portable computer 100 is substantially smaller in size in terms of both volume and weight. An example dimensional size of the portable computer 100 is 140 mm long, 100 mm wide, and 30 mm thick (while closed), with a weight of approximately one pound. The display screen on the second portion 104 is of a resolution comparable to a desktop computer monitor. In general, the size of the display screen, the size of the internal components (e.g., chips and circuit boards) located within the first portion 102, and the strategic placement of the internal components (e.g., density), and other factors will influence the overall form factor of the portable computer 100. As illustrated in FIG. 1, the portable computer 100 has a size such that it can be held securely in a hand 106 of a user.

FIG. 2 shows a first set of fins 200 located at an underside surface 202 of the portable computer 100 of FIG. 1 in accordance with an embodiment of the invention. The fins 200 are located at the rear (back) end of the portable computer 100, in a location that is generally where the user's hand(s) 106 does not hold the portable computer 100. This location for the fins 200 is selected because heat can be dissipated from this location and can be sufficiently distant from the user's hand(s) 106 during hand-held operation, thereby minimizing discomfort or potential burn injury. It is appreciated that in some embodiments, however, where the portable computer 100 is expected to be docked most of the time (for instance), the fins 200 need not necessarily be located in non-hand-holding regions.

Example techniques to dissipate heat from a portable computer, while in a hand-held operation, are disclosed in co-pending U.S. application Ser. No.______ (Attorney Docket No. 930086.404), entitled “HEAT DISSIPATION FROM A HAND-HELD PORTABLE COMPUTER,” filed concurrently herewith, assigned to the same assignee as the present application, and which is incorporated herein by reference in its entirety. This co-pending application discloses example techniques to dissipate heat from non-hand-holding areas of a portable computer, including strategic placement of the heat generating, heat carrying, or heat dissipation components in these areas. For brevity, details of these heat dissipation techniques will not be provided herein, since the present application is focused on use of a docking station for heat removal while docked. The reader is nevertheless invited to review the co-pending application for information that may be of interest.

The fins 200 operate to increase the available surface areas for heat dissipation. The heat is generated by the internal electronic components of the portable computer 100, captured by one or more heat sinks or heat pipes, and then carried to the fins 200 for dissipation therefrom. In an embodiment, the fins 200 are integrated or otherwise formed with the housing for the portable computer 100, and comprise a heat conductive (and heat dissipative) material. An example material suitable for the fins 200 is a magnesium alloy, copper, or other suitable heat-conductive and heat-dissipative material. The fins 200 may be of any suitable size, shape, number, spacing, or other configuration or arrangement that provides the desired thermal performance.

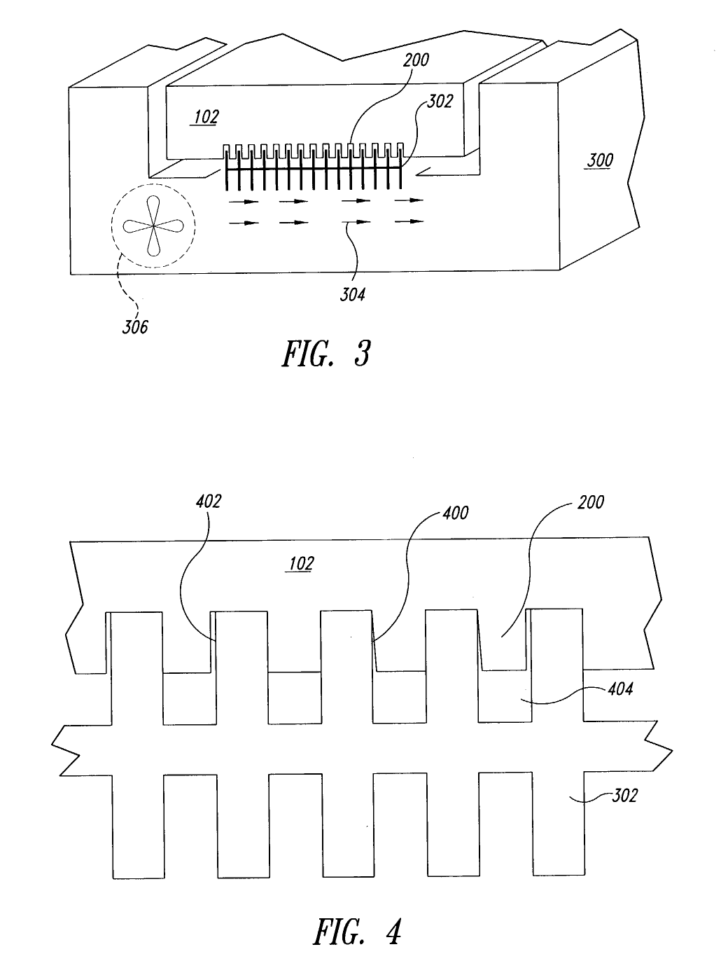

FIG. 3 depicts heat removal from the portable computer 100, while docked, in accordance with a first embodiment of the invention. The portable computer 100 (folded) is placed in a docking station 300. The docking station 300 can include a variety of interfaces, such as serials ports, monitor ports, Universal Serial Bus and IEEE 1394 ports, and other interfaces, plus CD, DVD, or other types of media drives. For brevity, detailed descriptions of these electronic docking connections will not be provided herein.

In accordance with an embodiment of the invention, the docking station 300 includes a thermal docking connection to accommodate the portable computer 100, in addition to the electronic docking connections. FIG. 3 illustrates one embodiment of the thermal docking connection as including a second set of fins 302 that form a male-to-male arrangement. That is, the first set of fins 200 from the portable computer 200 form a set of female fins that substantially mate (or otherwise mechanically couple to) the male fins on one side of the second set of fins 302. The male fins on the other side of the second set of fins 302 are exposed to an airflow 304 from a fan 306 built into the docking station 300.

The second set of fins 302 may be made from a suitable heat conductive and heat dissipative material, such as copper. The second set of fins 302 may also be made of the same magnesium alloy as the first set of fins 200, or they may be made of other types of material that provides the requisite thermal performance and durability from wear and tear. Moreover, because the docking station 300 generally has less size restrictions than the portable computer 100, the second set of fins 302 may be designed to be relatively larger in size and/or number than the first set of fins 200, thereby providing more surface area for heat dissipation.

In operation, the portable computer 100 is docked into the docking station 300. The docking is performed in a manner such that the electrical docking connections are established and such that the thermal docking connections (between the fins 200 and 302) are substantially mated. The docking (including the mating) is also performed such that the requisite mechanical stability and rigidity are provided. As the portable computer 100 generates heat during its docked operation, the generated heat is transferred from the heat-generating internal components of the portable computer 100 to the first set of fins 200. From there, the heat is transferred to the first side of male fins of the second set of fins 302, and then onto the second side of male fins of the second set of fins 302. The second side of male fins is disposed in a channel (or other region in the docking station 300) that is exposed to the airflow 304. The fan 306 produces the airflow 304 to carry the heat away from the second set of fins 302 to open air.

While the fan 306 generating the airflow 304 has been described herein, it is appreciated that other heat-transport techniques, elements, or mechanisms may be used. For example, it is possible to provide an embodiment where the fins 302 are cooled via a water (or other liquid) coolant. In one embodiment, a fan-less docking station 300 can be provided, wherein the fins 302 are cooled by exposing them to the ambient air (such as via the backside of the docking station 300).

FIGS. 4-5 illustrate example fin-mating implementations that are usable for the embodiment of FIG. 3. FIG. 4 illustrates the first set of fins 200 and the second set of fins 302 that are generally rectangular in shape. For most efficient heat transfer, there is physical contact between most of the interfacing surfaces. It is appreciated, however, that there may be some air gaps or spacings 400 and 402 that are present, and are the result of mechanical tolerances, wear and tear, imperfections, etc. Air gaps 404 may or may not be present between the tips of the fins 200 and the intersection of the male-to-male arrangement 404. If present, air from the fan 306 can circulate through the air gaps, thereby providing additional heat dissipative surfaces.

FIG. 5 illustrates the first set of fins 200 and the second set of fins 302 that are generally triangular in shape. As before, maximum surface-to-surface contact is desired, although some spacings 500 may be present. In the illustrated embodiment of FIG. 5, one side of the fins 302 (that mate with the fins 200) is triangular in shape, while the opposing side is rectangular. It is appreciated that these are simply examples, one or both sides of the fins 302 may be triangular, rectangular, arcuate, spherical, or other suitable shape that provides the requisite mechanical coupling and thermal performance.

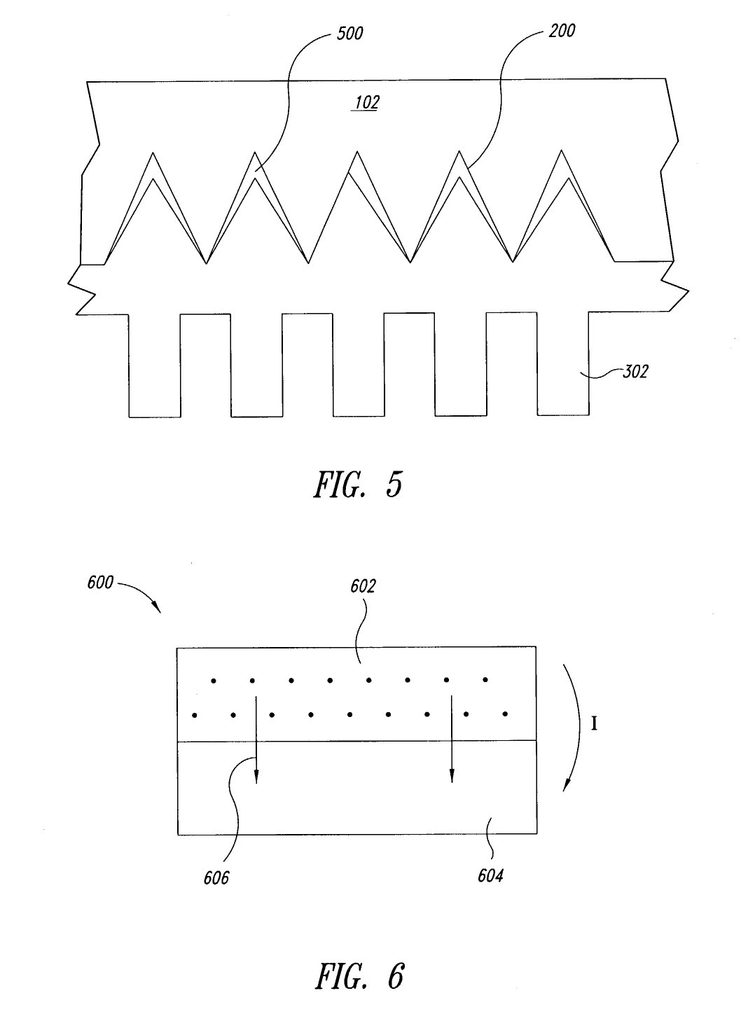

FIG. 6 symbolically illustrates a peltia device 600 that can be used by an embodiment of the invention to cool the docked portable computer 100. The peltia device 600 is an active semiconductor device. It comprises a PN junction formed by first and second semiconductive regions 602 and 604, respectively. When a current I (or voltage) is applied to the peltia device 600, carriers (indicated as dots in FIG. 6) from the first region 602 travel to the second region 604. This carrier movement (indicated by arrows 606) causes a rapid cooling of the first region 602 and a temperature rise in the second region 604. Very cold temperatures may be rapidly obtained on the surface of the first region 602, and the resultant heat may be removed from the second region 604 by a fan, by liquid cooling, or other cooling technique.

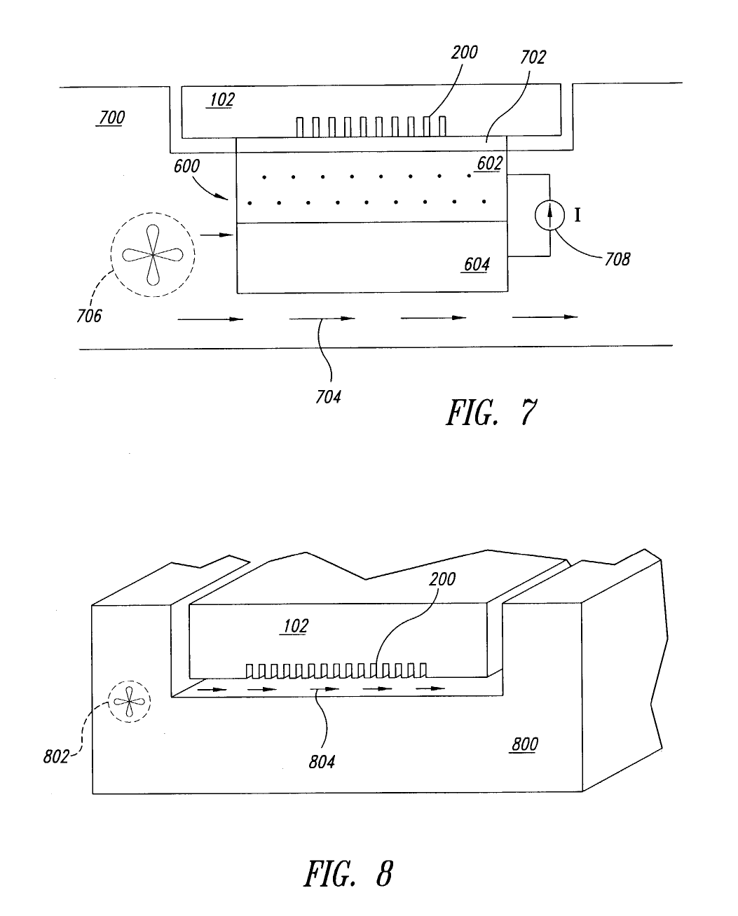

FIG. 7 depicts heat removal from the docked portable computer 100, using the peltia device 600 of FIG. 6, in accordance with a second embodiment of the invention. The peltia device 600 is integrated into or otherwise coupled to a docking station 700. The first region 602 of the peltia device 600 is positioned to face the docked portable computer 100, while the second region 604 of the peltia device 600 is exposed to an airflow 704 from a fan 706.

A suitable heat conductive material 702 may be positioned between the first region 602 and the underside surface 202 of the docked portable computer 100 in one embodiment. For example, the material 702 may be made of a copper or magnesium alloy or other suitable heat-conductive and heat-dissipative material, and is positioned in a manner such that the fins 200 (or other heat dissipative surface of the portable computer 100) sit on top of the material 702. In another embodiment, the bottom casing of the portable computer 100, such as some of the fins 200 or other heat-conductive bottom portion, can sit directly on top of the first region 602 without the need for the material 702. A current or voltage source 708 is coupled to the peltia device 600 to trigger the carrier migration.

In operation, the portable computer 100 is operating while it is docked and is generating heat. The peltia device 600 is turned on via the source 708, thereby causing the first region 602 to cool, which draws the heat from the fins 200 and through the material 702. That heat is pulled to the second region 604 via thermodynamics, and is carried away by the airflow 704 from the fan 706 to open air.

It is noted that since the peltia device 600 (as well as the source 708) generate their own heat, in addition to the heat pulled from the portable computer 100, a bigger or faster fan 706 is used in an embodiment of the invention. The larger or faster fan 706 provides the requisite heat-carrying strength to remove the heat from the second region 604 of the peltia device 600.

FIG. 8 depicts heat removal from the docked portable computer 100 in accordance with a third embodiment of the invention. In FIG. 8, the portable computer 100 is docked in a docking station 800 that does not necessarily have the male-to-male arrangement or peltia device described previously. Rather, the fins 200 of the portable computer 100 are exposed to an airflow 804 generated by the docking station's 800 fan 802. Thus, an air gap may be provided in the docking station 800, adjacent to the location where the fins 200 are positioned once the portable computer 100 is docked, to allow the airflow 804 to circulate between and through the fins 200.

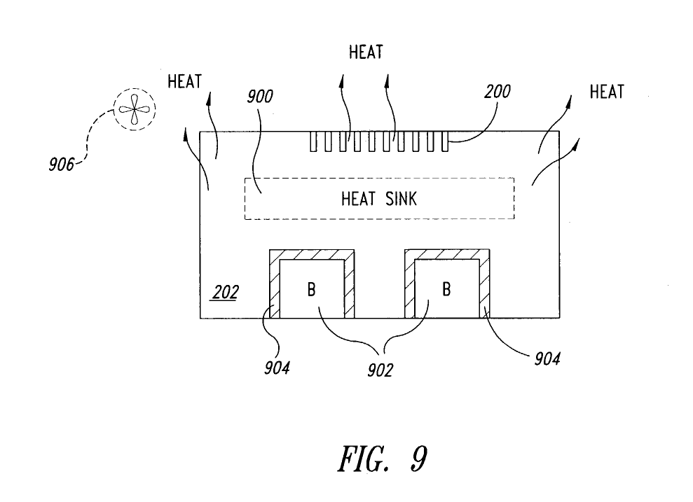

FIG. 9 illustrates heat removal from the underside surface 202 of the docked portable computer 100 in accordance with a fourth embodiment of the invention. The example of FIG. 9 may be used in conjunction with the forced-air technique of FIG. 8, with the peltia device implementation of FIG. 7, with the fin-mating implementation of FIG. 3, or with other arrangements.

In FIG. 9, the bottom housing of the portable computer 100 (and in particular the material that forms the underside surface 202) is made from a heat conductive material. For example, the fins 200 and the underside surface 202 can both be made from the same heat-conductive magnesium alloy, copper, or other suitable heat-conductive and heat-dissipative material. This material then dissipates or radiates heat that is generated by the internal electronic components.

In an embodiment, one or more heat sinks 900 for these internal electronic components are thermally coupled to the bottom housing. Heat pipes or the electronic components themselves may also be thermally coupled to the bottom housing. Batteries 902 (or other electronic components that should not be exposed to heat) are insulated with insulation 904. A dock fan 906 blows air along the underside surface 202 to carry away the heat to open air.

Once the thermal docking connection is established and as the heat is being removed from the docked portable computer, the voltage and frequency of the internal processor of the portable computer can be raised to levels above those of normal hand-held operations and above those of conventional hand-held devices. For example and because heat is being effectively removed, operation at approximately 2× normal operation can be achieved by providing greater power for the electronic components of the portable computer 100, while docked. Accordingly, use of the docking station 300, 700, or 800 for cooling allows full-performance operation compared to other laptop solutions while docked.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system, comprising:
a portable device that generates heat during operation;
a docking station having a connection to accommodate the portable device, the connection being coupleable to the portable device to receive the heat generated by the portable device during operation of the portable device while in the docking station; and
a heat transport mechanism included with the docking station to substantially remove the heat received by the connection.

2. The system of claim 1 wherein the portable device comprises a hand-held computer.

3. The system of claim 1 wherein the heat transport mechanism comprises a fan to generate an airflow that flows over the connection to remove the heat therefrom.

4. The system of claim 1 wherein the heat transport mechanism includes a liquid coolant to remove the heat from the connection.

5. The system of claim 1 wherein the portable device includes a first set of fins to dissipate the heat generated by the portable device, and wherein the connection of the docking station includes a second set of fins having:
a first side of fins coupled to substantially mate with the first set of fins of the portable device to receive the heat dissipated by the first set of fins; and
a second side of fins, positioned opposite to the first side of fins, to allow removal of the heat received by the first side of fins by the heat transport mechanism.

6. The system of claim 5 wherein the second set of fins comprises a male-to-male arrangement, and wherein the first set of fins of the portable device comprises a female arrangement.

7. The system of claim 5 wherein the fins of either the first set of fins or the second set of fins comprises at least one of a rectangular shape, triangular shape, spherical shape, and arcuate shape.

8. The system of claim 5 wherein the first set of fins is located at a rear area of an underside surface of the portable device.

9. The system of claim 5 wherein the fins of either the first set of fins or the second set of fins comprises at least one of a magnesium alloy and copper.

10. The system of claim 1 wherein the connection of the docking station includes a peltia device to receive the heat generated by the portable device.

11. The system of claim 10 wherein the docking station further comprises:
a heat conductive material, positioned over a first region of the peltia device and comprising part of the connection, to mate with the portable device to receive the heat generated therefrom; and
a source, coupled to the first region of the peltia device and to a second region of the peltia device, to activate the peltia device in a manner that the first region becomes cooler relative to the second region to draw the heat from the portable device through the heat conductive material, wherein the drawn heat is transferred from the first region to the second region, and wherein the heat transport mechanism is coupled to remove the transferred heat from the second region.

12. The system of claim 1 wherein an underside surface of the portable device is thermally coupled to its internal components that generate the heat, the underside surface being coupleable to the connection of the docking station to allow dissipation of the heat from the underside surface.

13. The system of claim 1 wherein the portable device includes a set of fins to dissipate the heat generated by the portable device.

14. The system of claim 1 wherein the portable device comprises at least one of a wireless communication device, display device, monitor, audiovideo equipment, and consumer electronic device.

15. An apparatus, comprising:
a docking station to receive a portable computer that generates heat while the portable computer is in operation, the docking station including:
a thermal docking connection that can be mated with the portable computer while the portable computer is in the docking station, the thermal docking connection being mated to the portable computer in a manner that draws the heat, generated by the portable computer, from the portable computer; and
a heat removal element to substantially remove the heat drawn from the portable computer.

16. The apparatus of claim 15 wherein the heat removal element comprises a fan that generates an airflow that can carry the heat away from the thermal docking connection.

17. The apparatus of claim 15 wherein the portable computer includes a plurality of fins, and wherein the connection of the thermal docking station includes another plurality of fins that substantially mate with the fins of the portable computer to transfer the heat from the fins of the portable computer, the heat removal element being positioned in a manner that substantially removes the transferred heat from the fins of the connection.

18. The apparatus of claim 15 wherein the connection comprises a peltia device to cool the portable computer.

19. The apparatus of claim 15 wherein the thermal docking connection comprises a heat transfer material positioned between the portable computer and the docking station.

20. The apparatus of claim 19 wherein the heat transfer material comprises air, and wherein the heat removal element comprises a fan to fan that air.

21. A method, comprising:
docking a portable device to a docking station;
operating the portable device while docked in the docking station; and
using the docking station to remove heat generated by the portable device while operating in the docking station.

22. The method of claim 21 wherein using the docking station to remove the heat includes fanning the portable device from the docking station.

23. The method of claim 21 wherein using the docking station to remove the heat includes:
substantially mating fins of the docking station with fins of the portable computer to transfer the generated heat to the fins of the docking station; and
removing the transferred heat from the fins of the docking station.

24. The method of claim 21 wherein using the docking station to remove the heat includes using a peltia device in the docking station to cool the portable computer.

25. The method of claim 19, further comprising raising an operating frequency of the device while docked in the docking station to a level above an operating frequency while in hand-held operation.
